(19) United States
(12) Patent Application Publication
(10) Pub. No.: US 2025/0262615 A1
(43) Pub. Date: Aug. 21, 2025

(54) HEMATOCRIT TUBE DISPENSER

(71) Applicant: ACCU-GLASS LLC, St. Louis, MO (US)

(72) Inventors: Craig STOUT, Port Matilda, PA (US); Benjamin Henry LASSANSKE, St. Louis, MO (US)

(21) Appl. No.: 18/581,455

(22) Filed: Feb. 20, 2024

(51) Int. Cl. B01L 3/02; G01N 35/10

(52) U.S. Cl. CPC B01L 3/0217; G01N 35/10; G01N 2035/1027

(57) ABSTRACT

A device for dispensing fluid for testing including a tube having a proximal end and a distal end, a cylindrical holding mechanism, and a plunger. The cylindrical holding mechanism includes an outer holding part for holding the tube within the outer holding part, an inner holding part configured to engage with the outer holding part, wherein one end of the inner part holding part is connected to a handle assembly, and a circumferential grip ring disposed between the outer holding part and the inner holding part to provide a differential resistive force at each side of the circumferential grip ring, wherein the tube extends through the inner holding part and the outer holding part. The plunger is configured to dispense the fluid contained in the tube.

### FIELD OF DISCLOSURE

The present invention is directed to a tube dispenser, or more particularly, to a dispenser for a hematocrit tube.

### BACKGROUND

Hematocrit dispensing pipettors most often utilize a thumb-activated mechanical device (i.e., actuator or plunger) that grips a capillary tube on a flared exterior end thereof. The currently marketed versions of these products have significant limitations. For example, to prevent a hematocrit tube from moving during the dispensing action, the pipettor is designed to engage on a flared proximal end of the hematocrit tube. These devices use a thumb activated dispensing rod to push a clay-based self-sealing plug down an internal bore of the hematocrit tube. This action dispenses blood plasma from the opposing end of the tube for testing. However, these types of dispensers have several restrictions. Such as, it requires that the hematocrit tube have a flared end, which adds complexity in manufacturing and cost. Also, the flared end of the tube is under tensile stress and rotational loading rather than a compressive force. Glass, the most often used material for a hematocrit tube, is weakest under tensile and rotational loading and prone to breaking. Breakage of a hematocrit glass tube, which contains collected blood, exposes the user and environment to potentially biohazardous substances. Moreover, breakage of the hematocrit tube can result in glass shards and increase risk of accidental injury (i.e., needle stick injury) to users in the laboratory and/or exposure to biohazardous bodily fluids. Finally, tube breakage also results in the loss of the sample and requires the disassembly and careful decontamination of the dispensing pipettor to remove any foreign matter, resulting in time consuming and laborious testing set up.

In one approach, to eliminate risks associated with glass hematocrit tube breakage, plastic hematocrit tubes have been used. However, current dispensing pipettors using plastic tubes prohibit the dispensing of the sample. These tubes do not have pre-inserted plugs for centrifugation and dispensing. In addition, the plastic tubes can easily slip out of conventional dispensers designed to grip the flared end. Furthermore, adding a flare to the plastic is not desirable because the plastic material can easily deform under the load. Finally, commercially available plastic hematocrit tubes are not compatible with other dispensers in the market as these tubes typically lack a flared end.

As to the issues associated with the dispenser itself, current dispensing pipettors lack adequate control over dispensing rate. Typically, the dispensers are held with two fingers during a plunging action, which can cause a reduction in control over the rate of dispensing. This minimal handling control often leads to a dispensing “burst” with the fluid in the hematocrit tube being ejected in an uncontrolled and overly rapid manner.

In view of above, there is a need in the art for a hematocrit tube dispenser that do not suffer from the above shortcomings.

### SUMMARY

In an example embodiment, a device for dispensing fluid for testing includes a handle, a cylindrical holding mechanism, and a plunger. The cylindrical holding mechanism includes an outer holding part for holding a tube within the outer holding part and an inner holding part configured to engage with the outer holding part, wherein one end of the inner part holding part is connected to the handle. The cylindrical holding mechanism further includes a circumferential grip ring disposed between the outer holding part and the inner holding part to provide a differential resistive force at each side of the circumferential grip ring, wherein the tube extends through the inner holding part and the outer holding part. The plunger is configured to dispense the fluid contained in the tube.

In another example embodiment, a device for dispensing fluid for testing includes a handle, a cylindrical holding mechanism configured to support a tube whereby the tube is slidably moveable through the cylindrical holding mechanism, and a circumferential grip ring disposed in the cylindrical holding mechanism to create a differential resistive force at each side of the circumferential grip ring. The circumferential grip ring is adapted to move between a first position and a second position, wherein, in the first position, the circumferential grip ring is positioned farther away from the first end of the tube to hold the tube against the cylindrical holding mechanism and wherein, in the second position, the circumferential grip ring is positioned closer to the first end of the tube to release the tube against the cylindrical holding mechanism.

In yet another example embodiment, a dispensing assembly for dispensing fluid for testing includes a tube having a first end and an opposed second end, the tube adapted to draw a fluid into the tube by virtue of capillary action and a dispenser adapted to hold and release the tube, the dispenser. The dispenser includes a handle, a cylindrical holding mechanism attached to the handle, and a plunger, disposed in the handle, configured to dispense the fluid contained in the tube. The cylindrical holding mechanism includes an outer holding part adapted to hold a tube therein, the tube having a proximal end and a distal end, an inner holding part configured to engage with the outer holding part, wherein one end of the inner holding part is connected to the handle, and a circumferential grip ring disposed between the outer holding part and the inner holding part to provide a differential resistive force at each side of the circumferential grip ring. The tube extends through the inner holding part and the outer holding part.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a perspective view of an exemplary a tube dispensing pipettor, according to an example embodiment of the present disclosure.

FIG. 2 is an exploded perspective view of an exemplary cylindrical tube holding mechanism of FIG. 1, according to an example embodiment of the present disclosure.

FIG. 3 is a cross-sectional view of an assembled cylindrical tube holding mechanism of FIG. 2, according to an example embodiment of the present disclosure.

FIG. 4 is a perspective view of an exemplary gripping ring, according to an example embodiment of the present disclosure.

FIGS. 5 and 6 are partial side cross-sectional views of a cylindrical tube holding mechanism, according to an example embodiment of the present disclosure.

FIG. 7 is a perspective view of an exemplary a tube and a sealing plug, according to an example embodiment of the present disclosure.

FIG. 8 is a cross-sectional view of a tube inserted into a cylindrical tube holding mechanism, according to an example embodiment of the present disclosure.

FIG. 9 is perspective view of a tube dispensing pipettor, according to another example embodiment of the present disclosure.

FIG. 10 is an exploded perspective view of a cylindrical tube holding mechanism of FIG. 9, according to another example embodiment of the present disclosure.

FIG. 11 is a cross-sectional view of an assembled cylindrical tube holding mechanism of FIG. 9, according to another example embodiment of the present disclosure.

FIG. 12 is a perspective view of an exemplary gripping ring of FIG. 9, according to another example embodiment of the present disclosure.

FIG. 13 is a partial cross-sectional view of an assembled cylindrical tube holding mechanism of FIG. 9, according to another example embodiment of the present disclosure.

FIGS. 14 and 15 are partial side cross-sectional views of a cylindrical tube holding mechanism of FIG. 9, according to another example embodiment of the present disclosure.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. Wherever possible, the same reference numbers will be used throughout the drawings to represent the same parts.

### DETAILED DESCRIPTION

As used herein, a “sample” may be but is not limited to a blood sample, or a portion of a blood sample, may be of any suitable size or volume, and is preferably of small size or volume. In some embodiments of the assays and methods disclosed herein, measurements may be made using a small volume blood sample, or no more than a small volume portion of a blood sample, where a small volume includes a volume between about 0.01 μL to a volume of about 50 mL.

As used herein, a “fluid” may be any fluid obtained or obtainable from a subject. A fluid may be, for example, blood, urine, saliva, tears, sweat, a bodily secretion, a bodily excretion, or any other fluid originating in or obtained from a subject. Exemplary bodily fluids include, without limitation, blood, serum, plasma, bone marrow, saliva, urine, gastric fluid, spinal fluid, tears, sweat, oil, glandular secretions, cerebral spinal fluid, semen, vaginal fluid, interstitial fluids derived from tumorous tissue, ocular fluids, placental fluid, amniotic fluid, cord blood, lymphatic fluids, cavity fluids, sputum, meconium, breast milk and/or other secretions or excretions.

As used herein, a “tube” may be a vessel to collect and hold the sample. In one implementation, the tube is a hematocrit tube used for collecting blood samples via capillary action and measuring the volume percentage of red blood cells in those samples. In some instances, the tube can be disposable. For example, the tube can be used once and disposed. Optionally, the tube can be reused any number of times. In some implementations, the tube can include both reusable and disposable components.

As used herein, “dispenser” or “pipettor” or any other dispensing mechanism can be a laboratory tool commonly used in chemistry, biology, and medicine to transport and dispense a measured volume of fluid. For example, the dispenser and/or any other portion thereof may be capable of receiving a tube containing a single type of sample, or multiple types of samples. For example, the dispenser may be capable of receiving a tube containing blood.

The present disclosure provides an improved tube dispenser that is designed to grip an outer diameter of a tube, e.g., a hematocrit tube, without the need for a flared end on the tube. This gripping action contains enough force that the tube is held in place while a dispensing rod pushes a plug down an internal diameter of the tube, thus dispensing the liquid contents from the opposing end thereof.

Further, the present device requires no additional features on the tube and can resist high dispensing forces. This provides the present device with a wider range of tube designs, such as, for example, changes in tube diameter, tube material, and/or plug design. In contrast, existing designs are compatible only with specifically matched tube and plug configurations, making it restrictive and limiting in design. Moreover, dispensing forces are highest at the initiation of dispensing due to entrance effects on the plug or static friction before movement. As such, the present device includes a gripping ring, which in relation to the end of the tube retains a material of the tube in compression at this critical moment and decreasing the chance of tube breakage.

The present device can be compatible or used with plastic tubes; unlike conventional devices, there are no adequate solution at present on the market.

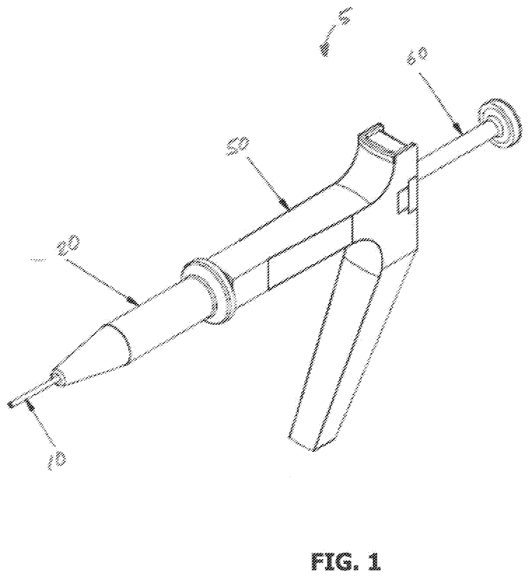

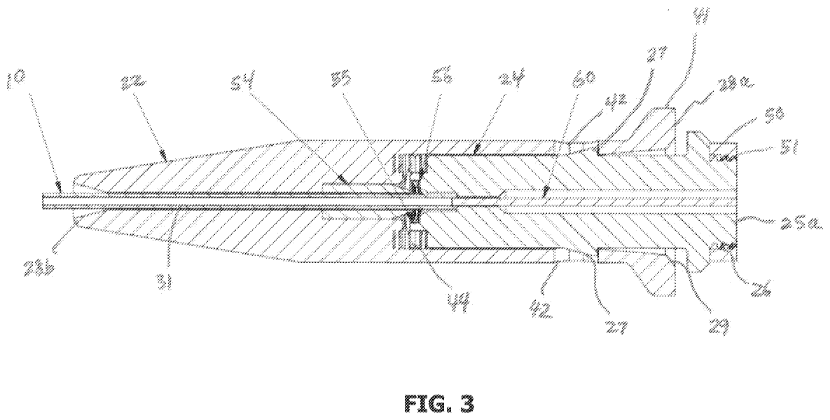

FIG. 1 illustrates one example embodiment of a tube dispenser 5 will now be described herein. The tube dispenser 5 includes a cylindrical tube holding mechanism 20 adapted to hold a tube 10 (i.e., hematocrit tube) therein and a handle assembly 50. The cylindrical tube holding mechanism 20 is attached to the handle assembly 50. In one implementation, one end 25a of the cylindrical tube holding mechanism 20 includes a threaded portion 26 that engages with corresponding threaded portion 51 of the handle assembly 50 (FIG. 3), so that the cylindrical tube holding mechanism 20 and the handle assembly 50 are connected in a tight manner. To describe differently, the cylindrical tube holding mechanism 20 includes an outer threaded connection 26 that cooperatively engages with an inner threaded connection 51 of the handle assembly 50, representing a female-male connection. It should be appreciated that other types of connections can be used, such as, but not limited to, including couplings, bushings, adapters, or union fittings. This design permits the cylindrical tube holding mechanism 20 to be easily detached from the handle assembly 50 to accommodate possibly other sizes and types of tube holding mechanisms. In addition, removal of the cylindrical tube holding mechanism 20 from the handle assembly 50 ensures proper cleaning and/or maintenance.

The cylindrical tube holding mechanism 20 and/or the handle assembly 50 can be made of any material, but preferably is made from a non-porous, inert, biocompatible material such as, for example, a plastic polymer. In some implementations, a portion or wholly, the cylindrical tube holding mechanism 20 and/or the handle assembly 50 can also be constructed of one material and coated with a non-porous, biocompatible material such as, for example, a polymer resin such as the one manufactured by Dupont and marketed under the name TEFLON.

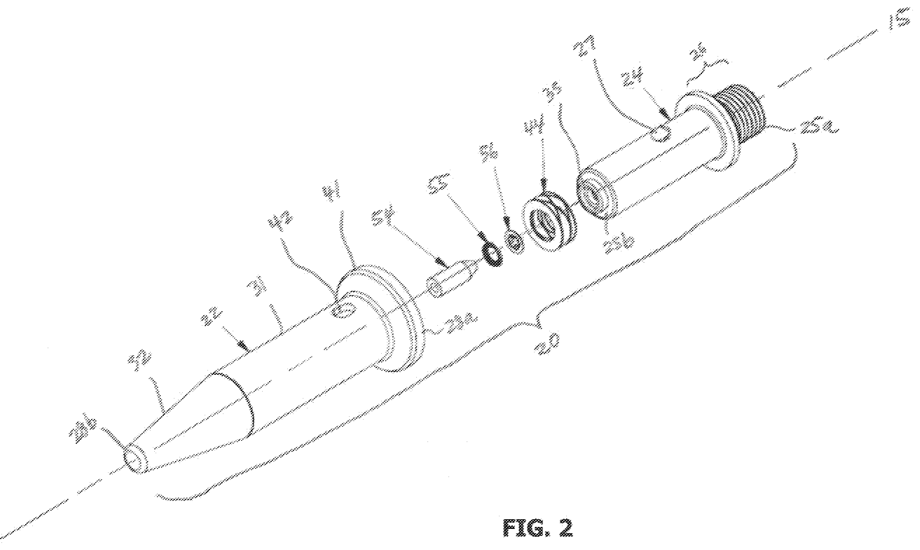

Referring now to FIGS. 2 and 3, the cylindrical tube holding mechanism 20 includes a first housing part 22 and a second housing part 24 that are cooperatively engageable with each other. In one implementation, the first housing part 22 is configured to receive the second housing part 24. That is, the first housing part 22 has a relatively large opening 29 formed at end portion 28a thereof, so as to receive end 25b of the second housing part 24. Preferably, an outer diameter of the second housing part 24 and an inner diameter of the first housing part 22 are sized so that, when joined, first housing part 22 and second housing part 24 tightly engage one another. At end portion 25b of the second housing part 24 includes a flange 35 extending outward in a plane generally parallel to a longitudinal axis 15 of the cylindrical tube holding mechanism 20. Flange 35 assists in aligning the second housing part 24 into the interior space of the first housing part 22, providing a tight fit. Flange 35 also fits within an opening of a spring member 44, which will be described in detail later.

On an exterior surface of the second housing part 24, a protrusion 27 is formed thereon. The protrusion 27 assists in maintaining a secure attachment between the first housing part 22 and the second housing part 24 by engaging with an opening 42 formed on a surface of the first housing part 22. In an example embodiment, as depicted in FIG. 3, two protrusions 27 are formed on the surface of the second housing part 24. It should be understood that there may be more than two protrusions 27. Other schemes for obtaining a secure connection between the first housing part 22 and the second housing part 24 can be used. For example, a tight press fit between two surfaces, i.e., outer surface of the second housing part 24 and the inner surface of the first housing part 22 can be used. That is, the outer diameter of the second housing part 24 and the inner diameter of the first housing part 22 are sized so that, when joined, the first housing part 22 and the second housing part 24 frictionally engage one another.

Referring back to FIG. 2, the first housing part 22 includes a first end 28a proximal to the user and a second end 28b distal from the user. In some implementations, second end 28b has a tapered portion 32 converging into a tip. At the first end 28a includes a flange 41 extending outward in a plane generally perpendicular to the longitudinal axis 15 of the first housing part 22. By way of non-limiting example, flange 41 can be circular or round. In other implementations, the flange 41 can be non-circular, such as, for example, oval. Flange 41 provides structural support to the cylindrical tube holding mechanism 20, in addition to reducing stress loads on the cylindrical tube holding mechanism 20. Moreover, the flange 41 can permit the user to grab the cylindrical tube holding mechanism 20 when detaching from the handle assembly 50.

The first housing part 22 includes a bore 31 that extends from the second end 28b (distal tip) to approximately a mid-portion of the first housing part 22, as shown in FIG. 3. In other words, the bore 31 extends from the second end 28b to the opening 29 formed in the first housing part 22. The bore 31 is configured to receive the tube 10 such that the tube 10 can slidably move within the bore 31. That is, the tube 10 can slidably move axially along in same direction as the longitudinal axis 15 for loading and removal from the cylindrical tube holding mechanism 20. By way of example, the tube 10 can be inserted from the second end 28b of the first housing part 22 so as to be loaded into the dispensing pipettor 5 and ready for dispensing via a thumb operated plunger assembly 60.

In some implementations, the tube 10 can be made from glass or plastic. Preferably, glass is most often used material for a hematocrit tube. In some implementations, at one end (proximal end) of tube 10, a flared end can be present. Typically, a conventional dispensing pipettor is designed to engage with the flared end to hold the tube 10 in its place during dispensing of the fluid sample. In other implementations, tube 10 is free of a flared end at one end. Accordingly, the present apparatus described herein is adaptable such that an unflared end or a flared end tube can be used with the dispensing pipettor 5. This is due to the fact that the engagement of the tube 10 occurs at a side surface of the tube 10 rather than at the end portion. As such, the present apparatus requires no additional features (e.g., flared end) on the tube 10, and hence, can resist high dispensing forces caused by the activation of the plunger. As a result, this provides a wider range of different tube designs. For example, changes in tube diameter, tube material, or plug design can all be accommodated. Unlike conventional dispenser designs, these devices are compatible with only specifically matched tube and plug configurations. Preferable, the present apparatus utilizes an unflared tube as this significantly reduces tube breakage caused by the dispensing forces (i.e., tensile and rotational loads).

In some implementations, tube 10 can include an anticoagulant (e.g., sodium or ammonium heparin) that keeps the blood from clotting. In this instance, tube 10 can have a color coded end to easily identify an anticoagulant treated tube from a plain tube. In some implementations, tube 10 can be coated or wrapped with a material to contain the fluid sample in the event of breakage and/or protect against cuts from broken glass. For example, the wrapped material can be a polyester film, such as, MYLAR. In other implementations, a protective layer such as a transparent or translucent layer overlies an outer surface of tube 10, permitting an operator or user to view the contents (e.g., liquid or fluid) therein. An exemplary tube 10 can have a length of approximately 3 in, an inner diameter of approximately 0.044 in, an outer diameter of approximately 0.080 in, and a volume of approximately 75 μL. It should be understood that other sizes and volumes can be employed depending on the specific use of sampling of the fluid.

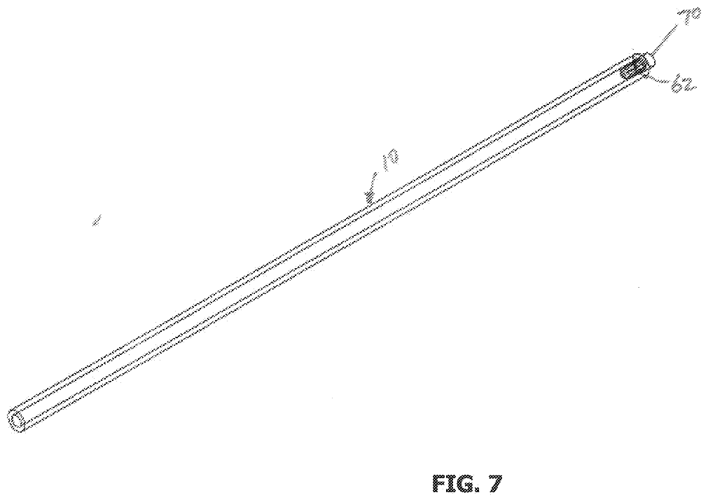

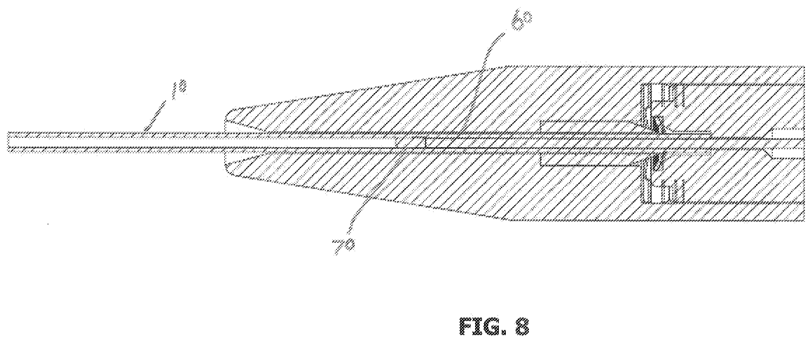

As shown in FIG. 7, at one end 62 (proximal end) of tube 10, a sealing plug 70 is provided, which is adapted to be inserted in the tube 10 to force the fluid out of the tube 10. The sealing plug 70 is at least partially insertable in the proximal end 62 and adapted to be slidably movable inside of the tube 10 caused by the movement of the plunger 60, as shown in FIG. 8. An exemplary plug can be a self-sealing plug, such as, for example, a clay based self-sealant plug. In other implementations, the plug can include at least one channel defining a passageway for extracting vapor contained in the tube as described in co-pending U.S. patent application Ser. No. 17/650,000 to Stout et al., entitled “Capillary Tube Closure,” incorporated herein by reference.

In use, once the tube 10 is loaded into the first housing part 22 of the cylindrical tube holding mechanism 20 by inserting the tube 10 into the bore 31 until the tube 10 engages with an end portion of the plunger 60 positioned inside of the second housing part 24, the plunger 60 is depressed to dispense the sample of fluid contents inside of the tube 10 from the second end 28b (distal end) of the first housing part 22. To eliminate the risk of dispensing too much or too quickly of the specimen volume (i.e., dispensing burst), the stroke of the plunger 60 is designed to only dispense the required volume consistently from tube to tube. That is, the plunger 60 has a controlled length and the stroke of the plunger 60 can be stopped at a specific location by features inside the handle 50. In an implementation, when dispensing plasma, the dispenser pipettor 5 is designed to dispense a max volume of 40% of the tube volume to prevent red cells and other cells from accidentally being dispensed. It should be understood that other volumes can be dispensed besides the one mentioned above. As shown in FIG. 1, in conjunction with the plunger 60, the handle assembly 50 includes a handle that is ergonomically shaped to improve fluid control. For example, the present handle design permits the user to operate with one hand by placing the hand on the ergonomically-shaped handle while placing the thumb on the plunger 60 for consistent applied pressure. Thus, the present handle assembly 50 provides the user with more control and reduces the likelihood of rapid and uncontrolled ejection of the fluid sample.

Referring back to FIG. 2, the cylindrical tube holding mechanism 20 includes a release mechanism 54, a sealing member 55, a gripping ring 56, and the spring member 44 provided between the first housing part 22 and the second housing part 24. The release mechanism 54, the sealing member 55, the gripping ring 56, and the spring member 44 are co-axially aligned and sized to maintain a tight connectivity with each other. To describe differently, the release mechanism 54, the sealing member 55, the gripping ring 56, and the spring member 44 are configured to receive the tube 10 such that the tube 10 extend through each component when assembled.

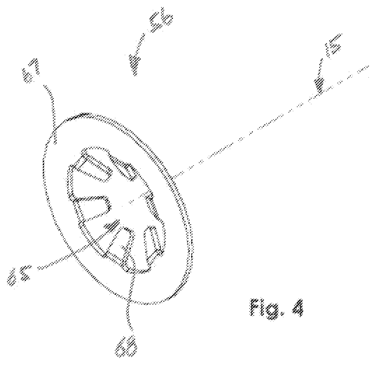

The cylindrical tube holding mechanism 20 utilizes the gripping ring 56 for a compliant interference in conjunction with an integrated release mechanism 54 for dispensing of the fluid sample in the tube 10. The compliance of the gripping ring 56 creates a differential resistive force from each side of the device. That is, this allows the tube 10 to be inserted with low force in one direction (i.e., towards the plunger 60) while creating a contemporaneous high resistive force in the opposite direction. As such, this force prevents the tube 10 from being ejected during dispensing of the fluid. To release the tube 10, the resistive force is removed via the release mechanism 54 deflecting (or deforming) the gripping ring 56 to the point of non-interference with the tube 10. In some implementations, the release mechanism 54 is inserted into an opening 65 of the gripping ring 56 to release the tube 10 therefrom (FIG. 4). In other words, the gripping ring 56 has a first position that is configured to hold the tube 10 in its place and a second position that is configured to release the tube 10 from the tube holding mechanism 20. For example, from its initial position, i.e., the first position, the second position is construed such that a portion of the gripping ring 56 moves closer to the (proximal) end 28b of the first housing portion 22. Due to the compliant design of the gripping ring 56 and controlled limits in the release mechanism 54, this configuration can be repeated through the lifecycle of the device. Also, the lifecycle of the tube holding mechanism 20 is maximized by limiting the force applied by the release mechanism 54 to not exceed the yield point of a material of the gripping ring 56.

Referring to FIG. 4, an opening 65 is formed in the gripping ring 56 to receive the tube 10 and the release mechanism 54. The gripping ring 56 includes a circumferential support member 67 with a plurality of gripping teeth 68 extending toward the opening 65. As shown, there are six teeth; however, it should be understood that there may be other than six teeth. In one implementation, each tooth is designed to slightly bend inward toward a direction of end 28b of the first housing part 22 to accommodate receiving the tube 10 in only one direction. That is, the plurality of teeth 68 are formed to create an inner gripping surface (i.e., opening 65), which is smaller than the outer diameter of the tube 10. For example, the opening 65 having the inner gripping surface can be 0.070 inch for receiving the tube 10 that has an outer diameter of 0.080 inch. The gripping ring 56 is retained by the sealing member 55 pressed into the tube holding mechanism 20. In some implementations, the sealing member 55 can be a washer-type sealing member used generally to prevent movement and/or provide protection to the gripping ring 56. In other functions, the sealing member 55 can also distribute load (i.e., compressive loads) caused by the plunger 60 and/or handle assembly 60 when in use. In some implementations, the sealing member 55 can be made from a variety of materials, such as, for example, plastic, rubber, or ceramic. Other materials, such as metal can be used, for example, stainless steel, carbon steel, zinc, copper, brass, iron, or a combination thereof.

In some implementations, the gripping ring 56 can be made from a metal material, such as, for example, stainless steel. Alternatively, the gripping ring 56 can be made from a pliable material such as, but not limited to, aluminum, tin, copper, silver, gold, brass, or a combination thereof. It should be understood that the material of the gripping ring 56 enables the gripping ring 56 to be pliable (i.e., deformable), while sufficient enough to spring back into its original position. In one implementation, the gripping ring has a thickness of 0.006 in of material.

In some implementations, the spring member 44 can be a wave spring. The spring member 44 is configured to apply force axially when compressed. For example, the spring member 44 is compressed when the plunger 60 applies pressure to expel the fluid in the tube 10.

As previously described, the release mechanism 54 is inserted into the gripping ring 56 to release the tube 10 from engagement. The release mechanism 54 includes a bore 62 for receiving the tube 10 such that the tube 10 extends therethrough. That is, in conjunction with operating with the handle assembly 50, the release mechanism 54 is configured to slidably move and release the tube 10 from engaging the gripping ring 56. More specifically, when the release mechanism 54 slidably moves towards the gripping ring 56 and enters the opening 65, the release mechanism 54 deflects (or deforms) the plurality of teeth 68 holding the tube 10 and releases the tube 10 to be removed. As a result, this removes the high resistive force placed on the outer surface of the tube 10.

In some implementations, the release mechanism 54 includes a tapered portion 71. As shown, the tapered portion 71 defines a frustum of a right cone formed in a peripheral edge of an end portion. The tapered portion 71 is adapted to engage the plurality of teeth 68 of the gripping ring 56, more specifically, to deform the plurality of teeth 68 towards the end 28b of the first housing portion 22 when inserted into the opening 65 of the gripping ring 56. Stated differently, the plurality of teeth 68 moves in a substantially perpendicular direction with respect to the longitudinal line 15. It should be understood that the tapered portion 71 is the only component of the release mechanism 54 that engages with the gripping ring 56. In one example embodiment, the tapered portion 71 has an angled tip of approximately 20 degrees, which approximates slightly more than the deformed angles of the plurality of teeth 68, as discussed above. In some implementations, the release mechanism 54 can be a one-piece assembly, i.e., the tapered portion 71 can be integrally formed with a body of the release mechanism 54. In other implementations, the release mechanism 54 can be a two-piece assembly, i.e., the tapered portion 71 can be a separate component from the body. In some implementations, the release mechanism 54 can be made from a metal material, preferably, aluminum. Other metal materials can be used, such as, for example, stainless steel, tin, copper, silver, gold, brass, or any combination thereof. In other implementations, the release mechanism 54 can be made from a plastic material.

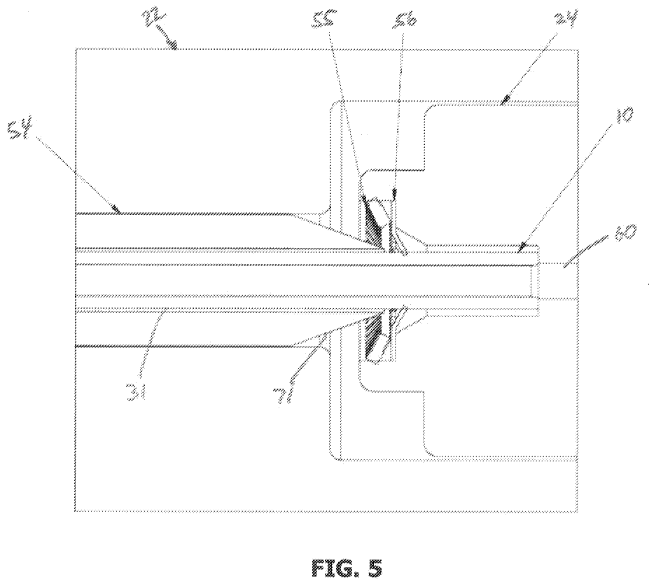

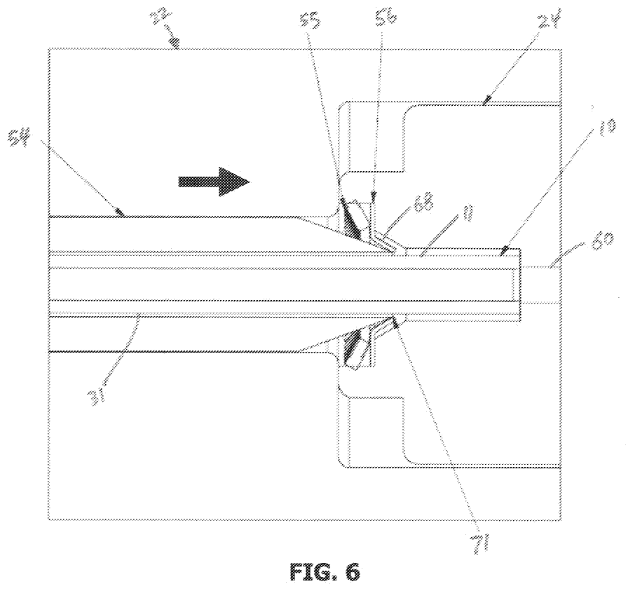

Referring now to FIGS. 5 and 6, these figures depict an engagement and release positions of the tube 10. Specifically, FIG. 5 illustrates the tube 10 in its engaged position, and FIG. 6 illustrates the tube 10 in its released position. As shown in FIG. 5, when the teeth 68 of the gripping ring 56 is engaged to an outer surface 11 of the tube 10, the tube 10 is restricted from moving during the dispensing step. That is, when the plunger 60 pushes against the tube 10 (or pushes the sealing plug 70) during dispensing of the fluid sample, the tube 10 is securely in place due to the teeth 68 being engaged to the tube 10. In other words, the gripping ring 56 is configured to grab the outer surface 11 of the tube 10 via the six teeth 68 to prevent movement of the tube 10. The teeth 68 are angled downward from a perimeter of the support 67 of the gripping ring 56, toward the tube 10, such that when the release mechanism 54 is inserted, the teeth 68 exert a pressure against the tube 10 to discourage the tube 10 from slipping or moving from the tube holding mechanism 20. As shown in FIG. 6, to release the tube 10 from the engaged position, the release mechanism 54 is axially moved towards the gripping ring 56 to deflect the teeth 68 thereof. That is, as the tapered portion 71 of the release mechanism 54 is inserted in the gripping ring 56, the tapered portion 71 pushes the teeth 68 radially outwardly to release the teeth 68 from contacting the surface 11 of the tube 10. At this point, there is no resistive force provided on the tube 10, permitting the tube 10 to be removed by the user. The movement of the release mechanism 54 is supplied by an external clamping force from the operator of the device on the outer surface of the first housing portion 22 and the rear side of the handle 50. In some iterations of this device, the clamping force can be facilitated by a flared feature on the first housing portion 22.

To replace the used tube 10, the user inserts a new tube 10 into an opening at end 28b of the first housing part 22. Because the teeth 68 of the gripping ring 56 are angled away from the axial direction of insertion, the tube 10 can be easily inserted into the tube holding mechanism 20 with minimal force while providing a high resistive force in the opposite direction.

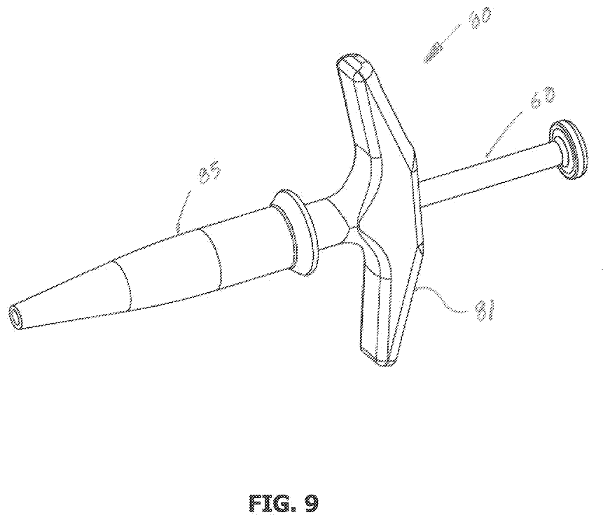

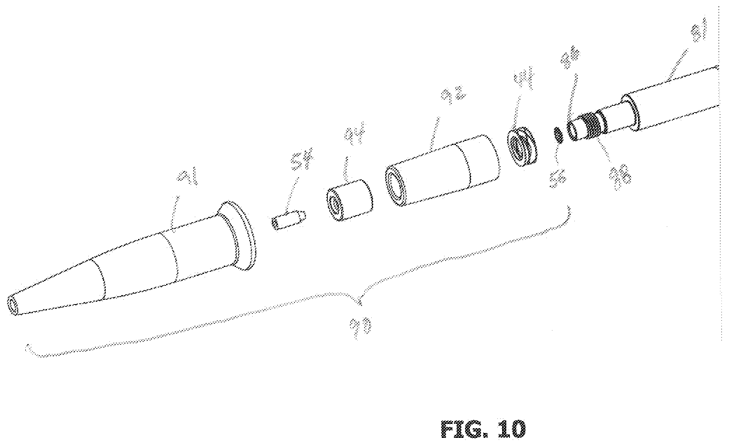

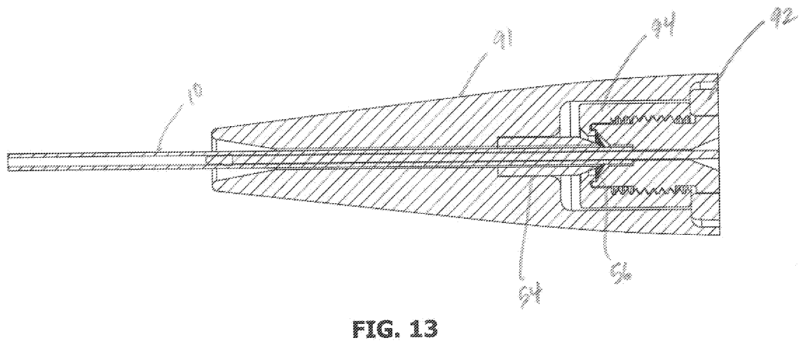

Referring now to FIGS. 9-15, an alternative dispensing device 80 is described herein, according to an exemplary embodiment. It is understood that the operation and use and similar parts of the dispensing device 80 is similar to the dispensing device 5 and not fully described hereinafter.

As shown in FIG. 9, when comparing dispensing device 5, dispensing device 80 includes a handle assembly 81 that is substantially T-shaped. This enables the user to handle and grab the dispensing device 80 with ease when activating the plunger 60. The handle assembly 81 is designed to engage a cylindrical holding mechanism 90. The cylindrical holding mechanism 90 includes a first housing part 91 and a second housing part 92 that are cooperatively engageable with each other. In one implementation, the first housing part 91 is configured to receive the second housing part 92.

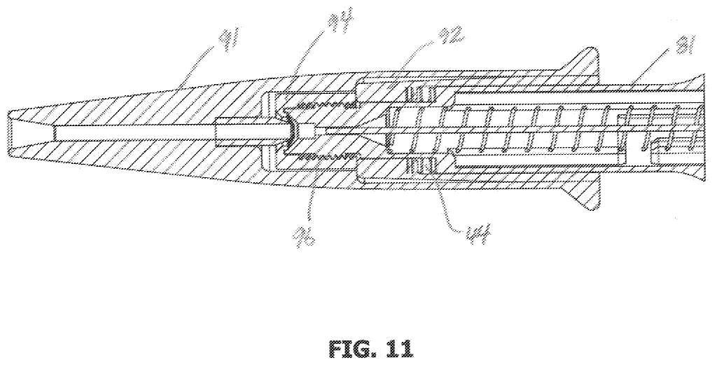

At one end 86 of handle 81, a threaded connection 88 is provided to engage a retainer 94 provided in the cylindrical holding mechanism 90. As shown in FIG. 11, the retainer 94 includes inner threads 96 that cooperatively engage with the threaded connection 88 of handle 81 for secure connection. This design ensures that the cylindrical holding mechanism 90 is securely connected to the handle assembly 81.

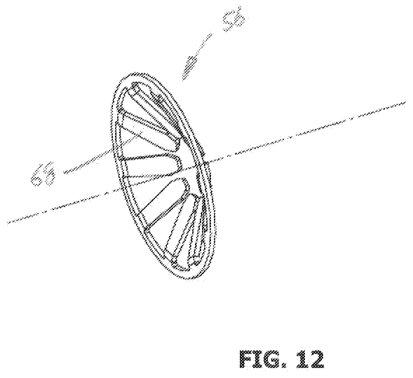

Similarly, the cylindrical tube holding mechanism 91 includes the release mechanism 54 and the gripping ring 56 provided between the first housing part 91 and the second housing part 92. However, the gripping ring of FIG. 12 is more compliant or operatable than the gripping ring 56 of FIG. 4. More specifically, the gripping ring 56 of FIG. 12 includes more teeth 68 whereby the teeth 68 extend further towards the center of the opening. This design allows the gipping ring 56 to have a compliant interference with the release mechanism 54. That is, a differential resistive force from each side of the device is fully provided while maintaining the tube 10 within the cylindrical tube holding mechanism 91 during dispensing of fluid.

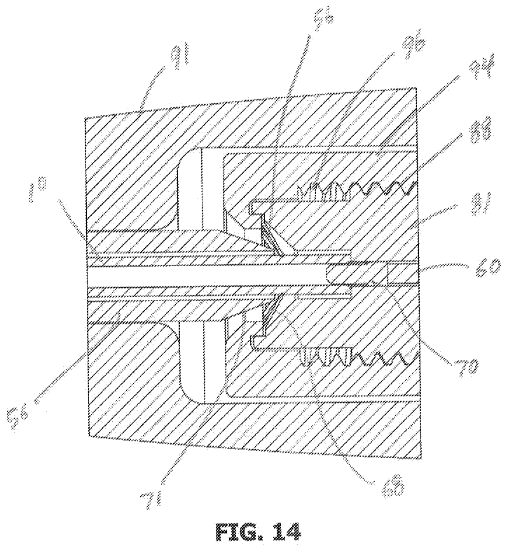

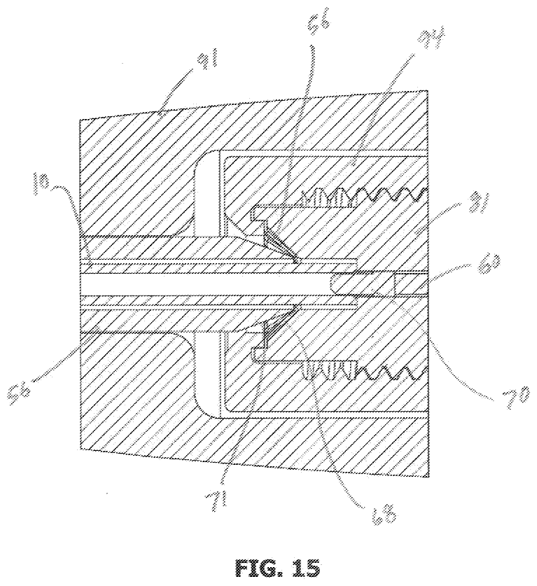

Referring to FIGS. 14 and 15, these figures depict an engagement and release positions of the tube 10. Specifically, FIG. 14 illustrates the tube 10 in its engaged position, and FIG. 15 illustrates the tube 10 in its released position. As shown in FIG. 14, when the teeth 68 of the gripping ring 56 is engaged to the tube 10, the tube 10 is restricted from moving during the dispensing step. That is, when the plunger 60 pushes the sealing plug 70 during dispensing of the fluid sample, the tube 10 is securely in place due to the teeth 68 being engaged to the tube 10. In other words, the gripping ring 56 is configured to grab an outer surface of the tube 10 via the plurality of teeth 68 to prevent movement of the tube 10. Further, due to the angled teeth 68, the teeth 68 exert a pressure against the tube 10 to discourage the tube 10 from slipping or moving from the tube holding mechanism 20. As shown in FIG. 15, to release the tube 10 from the engaged position, the release mechanism 54 is axially moved towards the gripping ring 56 to deflect the teeth 68 thereof. That is, as the tapered portion 71 of the release mechanism 54 is inserted in the gripping ring 56, the tapered portion 71 pushes the teeth 68 radially outwardly to release the teeth 68 from contacting the surface of the tube 10. At this point, there is no resistive force provided on the tube 10, permitting the tube 10 to be removed by the user.

In some implementations, the dispensing device may include an information storage member. The information storage member may be at least one of: a barcode, quick response (QR) code, image, shape, word, number, alphanumeric string, color, or any combination thereof, or any type of visual information storage member. Others may use information storage members that are not in the visible spectrum. Others may use RFID tags, RF information storage members, IR emitting tags, or other markers that do not rely on identification through signals sent through the visual spectrum. In some implementations, the information storage member may be positioned to be on the dispenser device and/or may be included on a side surface of the tube. In some implementations, the information storage member may be used to identify sample, volume sample, and/or types of sample in tube. Optionally, there may be one or more information storage member per sample tube. Information storage units may identify the sample collection device, one or more individual sample tubes within the device, or components of the device. In some instances, the sample collection device, a portion of the sample collection device, and/or the sample vessels may be transported. In one example, the sample collection device or a portion of the sample collection device, may be transported via a delivery service, or any other service described elsewhere herein. The sample vessel may be delivered so that one or more tests may be performed on the sample.

In some implementations, the present device may be used in a variety of applications. This includes any fluid sampling or dispensing process that requires holding a tube or other shaped duct while applying a compressive force to dispense the contents. Some examples include blood chemistry screening, disease and virus testing, and blood typing. In some implementations, other application is in the milk production industry where milk is collected into a hematocrit tube, centrifuged, and dispensed into an analyzer to test the fat quality and concentration, for example.

As described herein, the term “user,” as used herein, refers to a health care professional providing medical treatment and/or medical advice to a subject. A health care professional may include a person or entity that is associated with the health care system. Examples of health care professionals may include physicians (including general practitioners and specialists), surgeons, physician assistants, nurses, lab technicians, and a wide variety of trained personnel to provide some type of health care service. A health care professional may work in or be affiliated with hospitals, labs, and health care locations, or also in academic training, research and administration.

As described herein, in general expressions, the term “proximal” end relates to an end being closest to the user, and the term “distal” end relates to an end being farthest from the user. Alternatively, in relation to the tube, the term “proximal” end relates to an end where the sealing plug engages thereof, and the “distal” end relates to an end closest to the user.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of.”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A dispensing device for dispensing a fluid for testing, comprising:
a handle;
a cylindrical holding mechanism attached to the handle, the cylindrical holding mechanism including:
an outer holding part adapted to hold a tube therein, the tube having a proximal end and a distal end;
an inner holding part configured to engage with the outer holding part, wherein one end of the inner holding part is connected to the handle; and
a circumferential grip ring disposed between the outer holding part and the inner holding part to provide a differential resistive force at each side of the circumferential grip ring;
wherein the tube extends through the inner holding part and the outer holding part; and
a plunger, disposed in the handle, configured to dispense the fluid contained in the tube.

2. The device of claim 1, further comprising a release mechanism, wherein the release mechanism cooperatively engages with the circumferential grip ring to release the tube from the cylindrical holding mechanism.

3. The device of claim 2, wherein the release mechanism cooperatively engages with the circumferential grip ring by deflecting a plurality of teeth of the circumferential grip ring in one direction.

4. The device of claim 3, wherein one end of the release mechanism includes a tapered portion, whereby at least a portion of the tapered portion extends into an opening of the circumferential grip ring and engages with the plurality of teeth for deflection.

5. The device of claim 4, wherein the plurality of teeth moves radially outwardly when the tapered portion extends into the opening of the circumferential grip ring.

6. The device of claim 4, wherein the tapered portion has an angled tip of approximately 20 degrees.

7. The device of claim 2, wherein:
in a first deflection position, the plurality of teeth is positioned farther from the proximal end of the tube to hold the tube against the cylindrical holding mechanism; and
in a second deflection position, the plurality of teeth is positioned closer to the proximal end of the tube to release the tube from the cylindrical holding mechanism.

8. The device of claim 2, wherein the release mechanism includes a bore such that the tube slidably extends through the bore.

9. The device of claim 2, wherein the outer holding part includes a female connection configured to engage with a male connection of the inner holding part including.

10. The device of claim 1, wherein the tube is a hematocrit tube.

11. The device of claim 10, wherein one end of the hematocrit tube is a straight unflared end.

12. A dispensing device for dispensing a fluid for testing, comprising:
a handle assembly;
a cylindrical holding mechanism configured to support a tube whereby the tube is slidably moveable through the cylindrical holding mechanism;
a circumferential grip ring disposed in the cylindrical holding mechanism to create a differential resistive force at each side of the circumferential grip ring, the circumferential grip ring being adapted to move between a first position and a second position,
wherein, in the first position, the circumferential grip ring is positioned farther away from a proximal end of the tube to hold the tube against the cylindrical holding mechanism,
wherein, in the second position, the circumferential grip ring is positioned closer to the proximal end of the tube to release the tube against the cylindrical holding mechanism, and
wherein the handle assembly is attached to one end of the cylindrical holding mechanism and includes at least a plunger configured to dispense the fluid contained in the tube.

13. The device of claim 12, wherein the cylindrical holding mechanism further includes:
a first holding part for holding the tube within the first holding part; and
a second holding part configured to engage with the first holding part.

14. The device of claim 13, wherein the second holding part includes a male connection cooperatively engaging with the first holding part that includes a female connection.

15. The device of claim 12, further comprising a release mechanism, wherein the release mechanism cooperatively engages with the circumferential grip ring to release the tube from the cylindrical holding mechanism.

16. The device of claim 15, wherein, in the second position, the release mechanism cooperatively engages with the circumferential grip ring to deflect a plurality of teeth formed in the circumferential grip ring.

17. The device of claim 16, wherein the release mechanism includes a tapered portion, whereby at least a portion of the tapered portion extends into an opening of the circumferential grip ring and engages with the plurality of teeth for deflection.

18. The device of claim 17, wherein the plurality of teeth moves radially outwardly when the tapered portion extends into the opening of the circumferential grip ring.

19. The device of claim 12, wherein the tube is a hematocrit tube.

20. The device of claim 19, wherein one end of the hematocrit tube is a straight unflared end.

21. A dispensing assembly for dispensing a fluid for testing, comprising:
a tube having a first end and an opposed second end, the tube adapted to draw a fluid into the tube by virtue of capillary action;
a dispenser adapted to hold and release the tube, the dispenser including:
a handle;
a cylindrical holding mechanism attached to the handle, the cylindrical holding mechanism including:
an outer holding part adapted to hold a tube therein, the tube having a proximal end and a distal end;
an inner holding part configured to engage with the outer holding part, wherein one end of the inner holding part is connected to the handle; and
a circumferential grip ring disposed between the outer holding part and the inner holding part to provide a differential resistive force at each side of the circumferential grip ring;
wherein the tube extends through the inner holding part and the outer holding part; and
a plunger, disposed in the handle, configured to dispense the fluid contained in the tube.
